(19) United States
(12) Patent Application Publication
(10) Pub. No.: US 2019/0128447 A1
(43) Pub. Date: May 2, 2019

(54) LIFTING DEVICE

(71) Applicant: ARTHUR DOTY, ROUND ROCK, TX (US)

(72) Inventor: ARTHUR DOTY, ROUND ROCK, TX (US)

(21) Appl. No.: 15/968,415

(22) Filed: May 1, 2018

Related U.S. Application Data
(60) Provisional application No. 62/492,749, filed on May 1, 2017.

(51) Int. Cl. F16L 3/217; F16L 3/24

(52) U.S. Cl. CPC F16L 3/217; F16L 3/24

(57) ABSTRACT

A lifting device is disclosed. The lifting device includes a device body having a pair of grippers and a pair of lifting means. The pair of grippers grips opposite side edges of a flange of a supporting beam to allow the device body to be suspended from the supporting beam. Each of the lifting means is connected to a corresponding one of the grippers. The lifting means can lift a pipeline away from the supporting beam.

### PRIORITY CLAIM

The present application claims priority under 35 U.S.C. § 119(e)(1) to provisional application No. 62/492,749 filed on May 1, 2018, the contents of which are incorporated herein by reference.

### BACKGROUND OF THE INVENTION

### 1. Technical Field

The present invention relates to lifting devices in general, and in particular to a lifting device for lifting a pipeline away from a supporting structure.

### 2. Description of Related Art

Industrial plants, such as chemical processing plants, oil refineries, etc., typically include long pipelines for transferring various types of liquid or gas. These long pipelines are commonly resting on supporting steel beams.

One common problem with the above-mentioned pipeline systems is that pipelines tend to expand and contract as a result of temperature fluctuations. Such temperature changes can caused by weather conditions, the difference in temperature between night and day, and/or simply a change of temperature of the liquid or gas in pipelines. The expansion and contraction of pipelines cause certain sections of the pipeline to undergo a movement with respect to the fixed steel beams, which generally generates an enormous amount of friction and can cause the pipelines to wear out. Corrosion and/or erosion due to fluid leaks from the pipelines are problems that occur very frequently.

Considerable effort is expended to prevent the above-mentioned problems. One effective strategy is to periodically lift the pipeline at each supporting beam and inspect for damages. If minor damage is detected, a typical remedy is to sandblast the corroded area and then to apply a protective coating. More extensive mechanical repair may be required if the wear or corrosion is severe.

In order to accomplish this kind of inspection and repair, a pipeline must be lifted by approximately six inches at each pipe-to-beam interface and temporarily suspended in that position while the work is performed. A crane and heavy equipment operator are usually employed to lift pipelines, and this method can be very costly. Alternatively, chain fails or other rigging equipment can be used on lower levels of a pipe rack to raise a pipeline, but this method can also be costly due to manpower and scaffolding requirements.

Consequently, it would be desirable to provide an improved apparatus for lifting a pipeline away from a supporting structure.

### SUMMARY OF THE INVENTION

In accordance with a preferred embodiment of the present invention, a lifting device includes a first device body having a first gripper for gripping one flange of a supporting beam, a second device body having a second gripper for gripping an opposite flange of the supporting beam to allow the first and second device body to be suspended from the supporting beam, a first lifting means coupled to the first device body, and a second lifting means coupled to the second device body. The first and second lifting means together can lift a pipeline away from the supporting beam.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIGS. 1A-1C are a front view, a left isometric view, and a right isometric view of a lifting device, respectively, in accordance with one embodiment of the present invention;

FIGS. 2A-2B are a front exploded view and a right isometric exploded view of the lifting device from FIG. 1, respectively, in accordance with one embodiment of the present invention; and.

FIGS. 3A-3C are a front view, a left isometric view, and a right isometric view of the lifting device from FIG. 1, respectively, mounted on a support structure, in is accordance with one embodiment of the present invention.

### DETAILED DESCRIPTION OF A PREFERRED EMBODIMENT

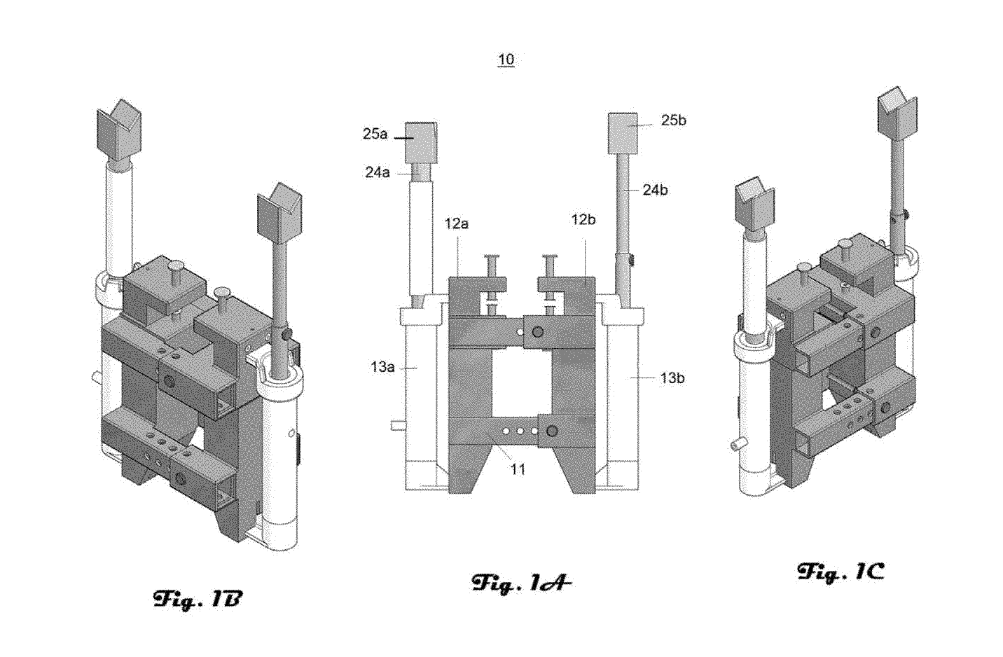

Referring now to the drawings and in particular to FIGS. 1A-1C, there are depicted a front view, a left isometric view, and a right isometric view of a lifting device, respectively, in accordance with one embodiment of the present invention. As shown, a lifting device 10 includes a device body 11, a pair of grippers 12a-12b attached on device body 11, and a pair of lifting means 13a-13b affixed to corresponding, grippers 12a-12b.

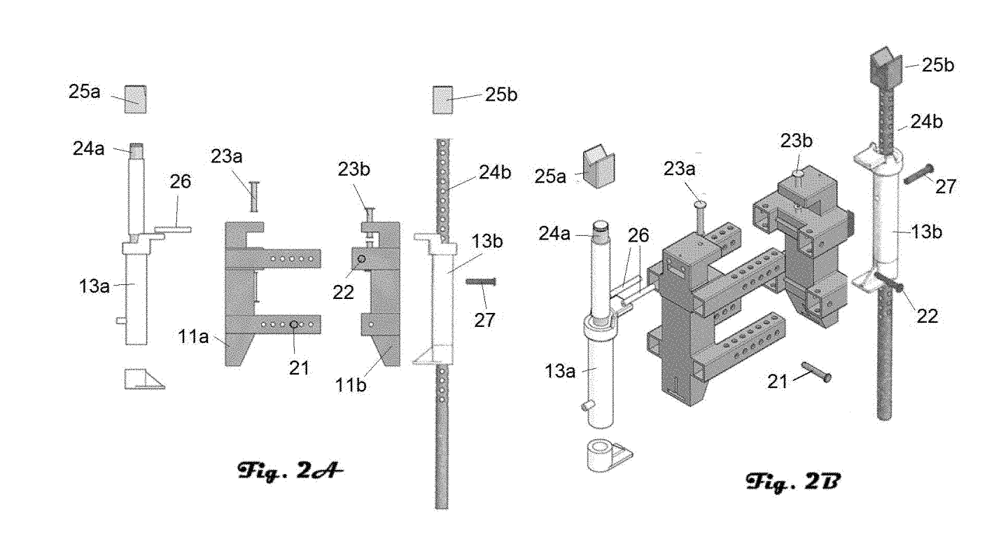

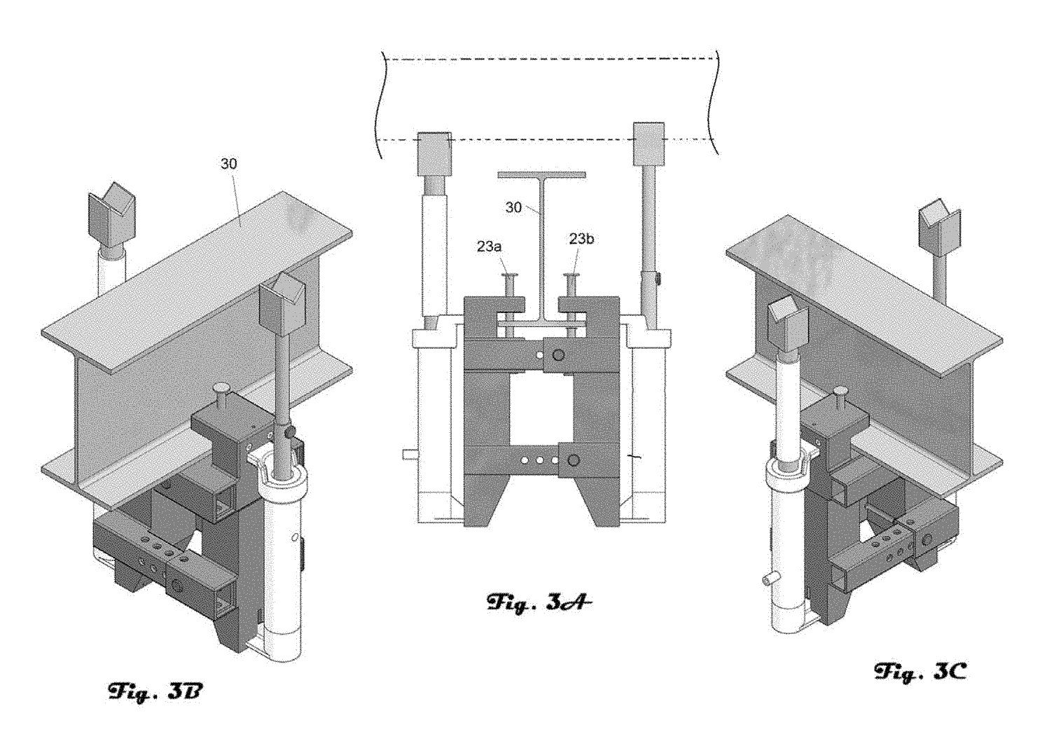

With reference now to FIGS. 2A-2B, there are illustrated a front exploded view and a right isometric exploded view of lifting device 10, respectively, in accordance with one embodiment of the present invention. As shown, device body 11 is formed by a first device body 11a and a second device body 11b secured to each other via locking pins 21. 22. The spacing between first device body 11a and second device body 11b can be adjusted to accommodate various widths of a support structure (such as support structure 30 in FIG. 3A).

Grippers 12a-12b include brake screws 23a-23b, respectively. Each of brake lit screws 23a-23b can be affixed to one of flanges of the support structure (such as support structure 30 in FIG. 3A), Brake screws 23a-23b secure first device body 11a and second device body 11b to the support structure (as shown in FIG. 3) such that first device body 11a and second device body 11b remain in one location of the flanges of the support structure until brake screws 23a-23b are loosen.

Lifting means 13a preferably includes a hydraulic jack capable of raising and/or lowing a jack rod 24a and a V-shaped head 25a attached to jack rod 24a. Lifting means 13a also includes a pair of rollers 26. On the other hand, lifting means 13b preferably includes a rod 24b and a V-shaped head 25b attached to rod 24b. The position of rod 24b with respect to the base of lifting means 13b can be manually adjusted accordingly, and the position can be locked via a locking pin 27. Although a hydraulic jack is only implemented in lifting means 13a in the present embodiment, it is understood by those skilled in the art that a hydraulic jack can also be implemented in lifting means 13b as well.

Referring now to FIGS. 3A-3C, there are illustrated a front view, a left isometric view, and a right isometric view of lifting device 10, respectively, mounted on a support structure, in accordance with one embodiment of the present invention. As shown, a support structure 30 acts as a support for lifting device 10 when a pipeline (shown in dash-lines in FIG. 3A) is being lifted by lifting means 13a-13b away from support structure 30. Support structure 30 is typically an I-shape steel beam, but support structure 30 can also be other types of beams.

Lifting, device 10 can be rapidly mounted on support structure 30 by inserting locking pins 21, 22 through appropriate holes on first device body 11a and second device body 11b. Rollers 26 located on lifting means 13a allow lifting device 10 to traverse smoothly along the flanges of support structure 30. Lifting device 10 can be rapidly dismounted from support structure 30 by removing locking pins 21, 22 through appropriate holes on first device body 11a and second device body 11b.

As has been described, the present invention provides an improved lifting device for lifting a pipeline with respect to a supporting structure.

While the invention has been particularly shown and described with reference to a preferred embodiment, it will be understood by those skilled in the art that various changes in form and detail may be made therein without departing from the spirit and scope of the invention.

What is claimed is:

1. A lifting device comprising:
a first device body having a first gripper for gripping one flange of a supporting beam;
a second device body having a second gripper for gripping an opposite flange of said supporting beam to allow said first and second device body to be suspended from said supporting beam;
a first lifting means coupled to said first device body; and
a second lifting means coupled to said second device body, wherein said first and second lifting means lift a pipeline away from said supporting beam.

2. The lifting device of claim 1, wherein one of said lifting means is powered by a hydraulic lift.

3. The lifting device of claim 1, wherein one of said lifting means includes a jack rod and a head.

4. The lifting device of claim 3, wherein said head has a V-shape.

5. The lifting device of claim 1, wherein one of said lifting means includes at least one roller.

6. The lifting device of claim 1, wherein one of said lifting means includes a locking pin.

7. The lifting device of claim 1, wherein said supporting beam has an I-shape cross-section.

8. The lifting device of claim 1, wherein said first and second device bodies are allowed to he coupled at various locations to accommodate various widths of said supporting beam.
